(19) United States
(12) Patent Application Publication
(10) Pub. No.: US 2007/0033807 A1
(43) Pub. Date: Feb. 15, 2007

(54) Planer with improved chip removal

(76) Inventor: Peter Wanninkhof, Oosterhout (NL)

Correspondence Address: KENYON & KENYON LLP, ONE BROADWAY, NEW YORK, NY, 10004, US

(21) Appl. No.: 10/547,403

(22) PCT Filed: Feb. 27, 2004
(86) PCT No.: PCT/NL04/00148

§ 371 Date: Oct. 6, 2006

(30) Foreign Application Priority Data
Feb. 28, 2003 (NL) 1022807

(51) Int. Cl. B26B 3/00

(52) U.S. Cl. 30/124

(57) ABSTRACT

A planer includes: a housing; a motor arranged in the housing; a planer knife roller cavity arranged in the housing; a planer knife roller arranged in the planer knife roller cavity and coupled for driving to the motor; and a shavings removal channel extending in the housing from the planer knife roller cavity. The shavings removal channel extends over its whole path with a directional component in the direction of movement of the planer.

### FIELD OF THE INVENTION

The present invention relates to a planer. The planer may include a housing, a motor arranged in the housing, a planer knife roller cavity arranged in the housing, a planer knife roller which is arranged in the planer knife roller cavity and coupled for driving to the motor, and a shavings removal channel extending in the housing from the planer knife roller cavity.

### BACKGROUND INFORMATION

Certain planers are conventional.

In such conventional planers, the shavings removal channel includes a part which extends in tangential direction and connects onto a part extending in axial direction of the planer knife roller. In certain planers, the motor is placed behind the planer knife roller. The connection of a tangential part of the channel to an axial part entails a change in direction of the airflow with the shavings entrained therein, which may reduce the effectiveness of the shavings removal. Due to the change in direction, the shavings will after all drop out of the airflow more easily and block the channel.

Another drawback of this conventional configuration is that a removal hose or a collection container for shavings is placed on the side of the planer. This obstructs the view of the workpiece.

### SUMMARY

According to an example embodiment of the present invention, a planer may be provided in which the chance of blockage of the channel may be greatly reduced.

According to an example embodiment of the present invention, the shavings removal channel extends over its whole path with a directional component in the direction of movement of the planer. This configuration may also provide the option of placing a removal device for the shavings at the rear so that it does not obstruct the view of the workpiece.

This measure may provide that the airflow which entrains the shavings is not subject to changes in direction, or hardly so, so that blockage may be considerably reduced.

According to an example embodiment, the housing is provided with a handgrip extending substantially in the direction of movement, and the shavings removal channel extends through the handgrip.

This example embodiment may obviate the problem of the motor usually blocking a direct route of the removal channel by guiding the channel over the motor, and even over the housing, through the handgrip. The configuration of the handgrip herein may provide the option of applying a bend with a large radius of curvature, so that the influence of the inertia of the shavings may be small and the shavings may be easily entrained with the airflow.

An example embodiment may provide the measure that the shavings removal channel extends above the motor and below the handgrip.

Use is made here of a configuration in which the housing is slightly elevated to provide space for the passage of the shavings removal channel above the motor.

According to an example embodiment, the shavings removal channel extends between the motor and the planer knife roller cavity. The motor is here arranged in a higher position so as to provide space for the channel.

The shavings removal channel may extend from the planer knife roller holder initially in tangential direction.

Example embodiments of the present invention are further described below with reference to the appended Figures.

### BRIEF DESCRIPTION OF THE DRAWINGS

FIG. 1 is a cross-sectional view of a planer according to an example embodiment of the present invention.

FIG. 2 is a cross-sectional view of a planer according to an example embodiment of the present invention.

FIG. 3 is a cross-sectional view of a planer according to an example embodiment of the present invention.

### DETAILED DESCRIPTION

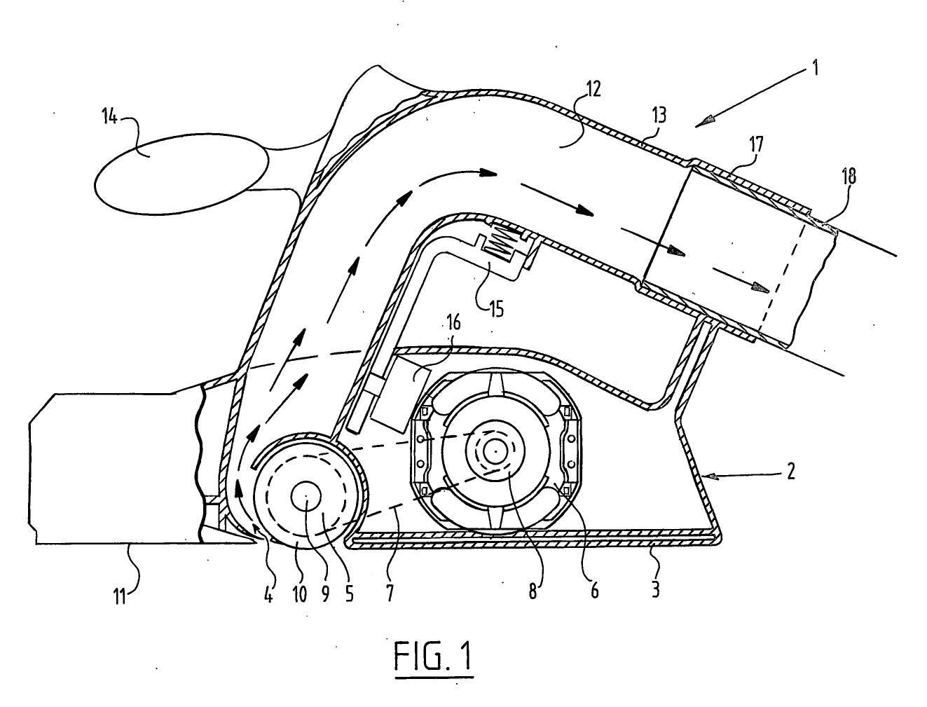

FIG. 1 shows in the form of a longitudinal section a planer designated as a whole with the reference character 1. The planer includes a housing 2 provided with a base plate 3. Recessed into the housing, in front of the base plate in the direction of movement, is a planer knife roller cavity 4 in which a planer knife roller 5 is placed. Planer knife roller 5 is mounted by a shaft 9 in bearings. The planer knife roller holder is driven by an electric motor 6 placed in the housing by a toothed belt 7 which is trained round a pulley 8 arranged on the motor shaft and a pulley 10 arranged on the planer knife roller shaft.

At the front of the housing is arranged an adjustable base 11.

The components described up to this point may all be found in conventional planers.

The planer hereof provides for the arrangement of a shavings removal channel 12 which extends through a handgrip 13 integrated into the housing. Handgrip 13 extends in the lengthwise direction of the planer, i.e., in the direction of movement of the planer.

Handgrip 13 is provided on its front side with an additional handgrip 14, in which the handgrips are formed such that a user grips handgrip 13 with one hand and handgrip 14 with the other hand to enable good control and guiding of the planer.

The shavings removal channel 12 connects in tangential direction onto planer knife roller cavity 4. The result hereof is that the air moving through the shavings removal channel is driven by the planer knife present on planer knife roller 5. The planer knife roller 5 is after all driven in rotation at high speed, in which the cutting edge of a planer knife arranged in planer knife roller 5 protrudes out of the planer knife roller and drives the air. This air is driven substantially in tangential direction so that a tangential airflow is created around the planer knife roller holder and continues further in the shavings removal channel.

Shavings removal channel 12 is dimensioned such that the passage thereof does not decrease in downstream direction. This may avoid blockage as much as possible.

Use may be made of the fan present on the motor shaft to strengthen the airflow. A fan may be necessary to cool electric motor 6, and this is usually arranged on the motor shaft. The airflow generated hereby may be used not only to cool motor 6 but to strengthen the airflow generated by the planer knife roller and being transmitted through shavings removal channel 12.

The planer includes a lever 15 for operating the switch 16. Use is made of lever 15 in order to place switch 16 as closely as possible to the electric motor, and thus may reduce the length of the connecting wires as much as possible. It hereby becomes still possible to operate the switch with the index finger of the hand with which handgrip 13 is being grasped.

Shavings removal channel 12 debouches at its end in a connector 17 for a removal hose, such as a vacuum cleaner hose. It is hereby possible to discharge the shavings to a vacuum cleaner. It is possible instead to connect other discharge mechanisms, such as a collection container for shavings or collection bag therefor.

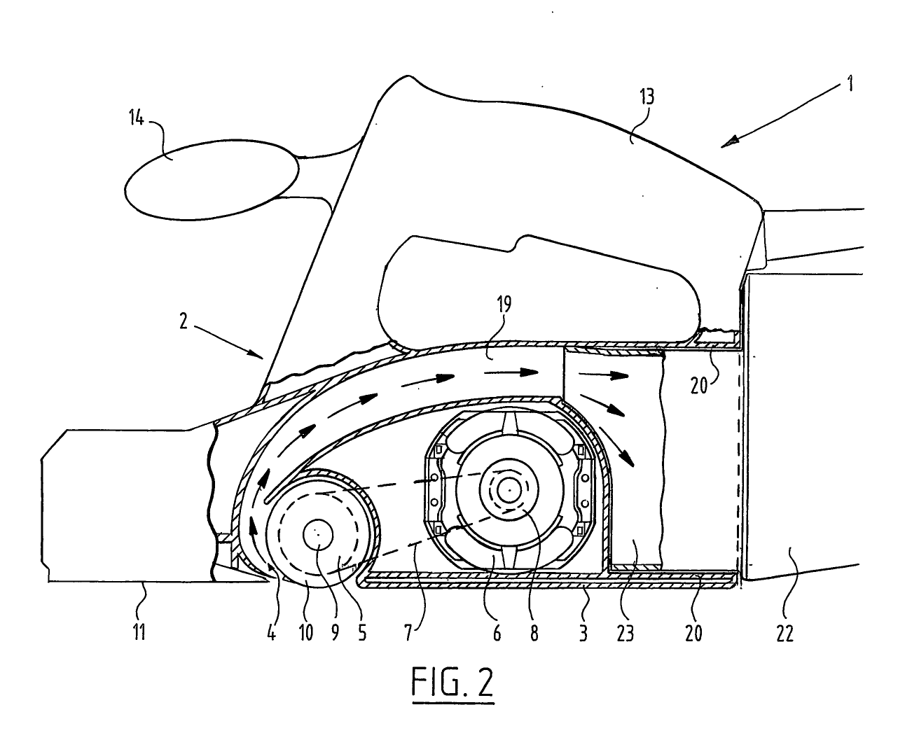

FIG. 2 illustrates an example embodiment, in which corresponding components are designated with the same reference numerals.

In this example embodiment, the removal channel 19 is not guided through a handgrip but is accommodated in the actual housing 2. Thus is achieved that the shavings removal channel 19 may be given a considerably shorter construction than shavings removal channel 12 of the planer illustrated in FIG. 1. This may provide that the passage thereof may take a smaller form.

As a result, a connector 20 may be placed connecting directly onto shavings removal channel 19, onto which connector 20 may be connected a shavings collection container 21 which is provided with a connecting piece 23 that may be coupled to connector 20.

It is also possible in this configuration to make connector 20 suitable for connection to a vacuum cleaner hose.

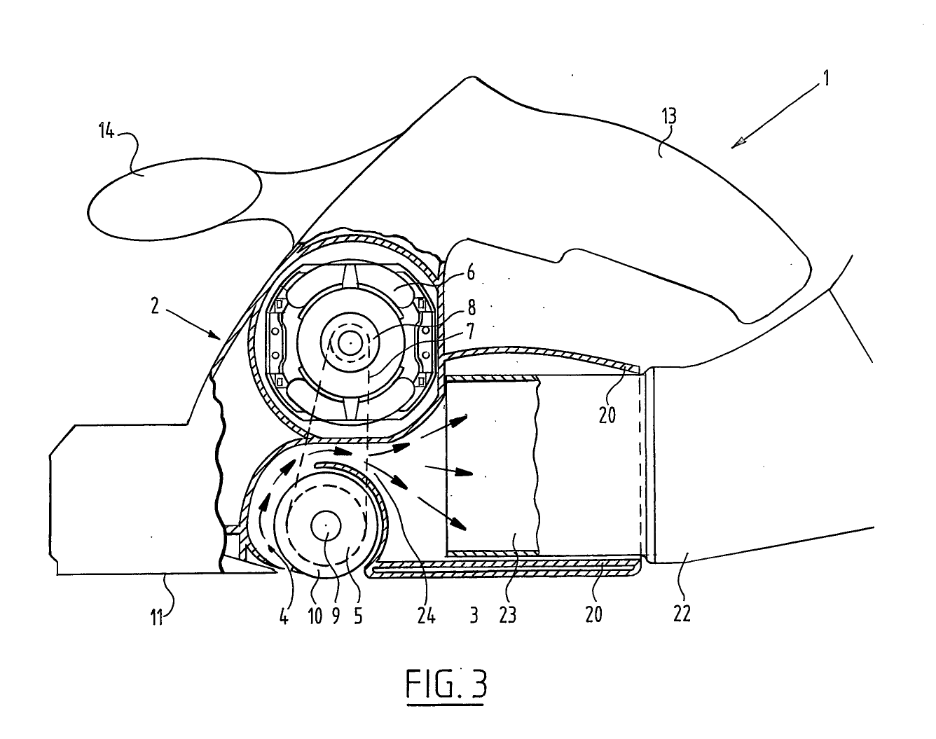

In FIG. 3 is illustrated a configuration in which shavings removal channel 24 branches directly from planer knife roller cavity 4 on the upper side thereof. Shavings removal channel 24 may have an exceptionally short length as it widens directly into a connector 20.

This configuration may allow motor 6 to be placed above the planer knife roller. This may provide an exceptionally short construction of the planer. This configuration moreover may result in an exceptionally short arrangement of the shavings removal channel, so that the danger of blockage may be extremely small.

Each of the above-described example embodiments may be combined with each of the options for shavings removal, such as a connection for a removal hose, such as a vacuum cleaner hose, a collection container or bag for shavings, etc.

1-9. (canceled)

10. A planer, comprising
a housing;
a motor arranged in the housing;
a planer knife roller cavity arranged in the housing;
a planer knife roller arranged in the planer knife roller cavity and coupled to the motor to be driven by the motor;
a shavings removal channel extending in the housing from the planer knife roller cavity, the shavings removal channel extending from the planer knife roller holder initially in a tangential direction, an entire length of the shavings removal channel extends with a directional component arranged in a direction of movement of the planer; and
a fan adapted to create an air flow with shavings, the planer knife roller adapted to drive air substantially in the tangential direction to create a tangential airflow around the planer knife roller that continues further in the shaving removal channel.

11. The planer according to claim 10, wherein the housing includes a handgrip extending substantially in the direction of movement, and that the shavings removal channel extends through the handgrip.

12. The planer according to claim 11, wherein the shavings removal channel extends above the motor and below the handgrip.

13. The planer according to claim 10, wherein the shavings removal channel extends between the motor and the planer knife roller cavity.

14. The planer according to claim 10, wherein a passage of the shavings removal channel remains at least the same in a flow direction.

15. The planer according to claim 10, wherein the shavings removal channel debouches into a connector.

16. The planer according to claim 15, wherein the connector is adapted to connect to a removal hose.

17. The planer according to claim 15, wherein the connector is adapted to connect to a collection container for shavings.

18. The planer according to claim 10, wherein the fan includes a fan arranged on a shaft of the motor.
